(19) United States
(12) Patent Application Publication
(10) Pub. No.: US 2018/0354227 A1
(43) Pub. Date: Dec. 13, 2018

(54) WINDOW FOR DISPLAY DEVICE AND DISPLAY DEVICE INCLUDING THE SAME

(71) Applicant: Samsung Display Co., Ltd., Yongin-si (KR)

(72) Inventors: Young Sang PARK, Yongin-si (KR); Ah Young KIM, Yongin-si (KR); Sung Guk AN, Yongin-si (KR); Ji Hyuk IM, Yongin-si (KR); Chul Ho JEONG, Yongin-si (KR)

(21) Appl. No.: 15/971,939

(22) Filed: May 4, 2018

(30) Foreign Application Priority Data
Jun. 13, 2017 (KR) 10-2017-0074402

(51) Int. Cl. B32B 5/12; B32B 7/12; B32B 7/02; B32B 27/12; B32B 27/38; B32B 27/28; C08J 7/04

(52) U.S. Cl. CPC B32B 5/12; B32B 7/12; B32B 7/02; C08J 7/042; B32B 27/38; B32B 27/281; B32B 27/12

(57) ABSTRACT

A window for a display device includes: a base substrate; and a protective layer provided on the base substrate, wherein the protective layer includes a plurality of sub-layers sequentially stacked, wherein the base substrate and the protective layer include at least one material selected from polyimide, polyethylene naphthalate, polycarbonate, polyurethane, polydimethylenesiloxane, rubber, and polyethylene terephtahlate, wherein the plurality of sub-layers are formed of different materials.

### CROSS-REFERENCE TO RELATED APPLICATION

This application claims priority to and the benefit of Korean Patent Application No. 10-2017-0074402, filed on Jun. 13, 2017, in the Korean Intellectual Property Office, the entire disclosure of which is incorporated herein by reference.

### BACKGROUND

### 1. Field

The following disclosure relates to a window for a display and a display device including the same.

### 2. Description of the Related Art

Recently, flexible display devices utilizing flat panel display devices have been developed. The flat panel display devices generally include a liquid crystal display (LCD), an organic light emitting diode (OLED), an electrophoretic display (EPD), and/or the like.

Because the flexible display devices have bending and folding characteristics, the flexible display devices can be folded or rolled. Accordingly, the flexible display devices with large screens can be conveniently carried. The flexible display devices can be applied in various suitable fields including not only mobile equipments (such as mobile phones, portable multimedia players (PMPs), navigation devices, ultra mobile PCs (UMPCs), electronic books, and electronic newspapers), but also TVs, monitors, and/or the like.

In addition, demands for windows that are flexible and strong against impact are increasing in implementing flexible display devices.

### SUMMARY

An aspect according to one or more embodiments is directed toward a window for a display device, which has flexibility and excellent impact resistance.

However, aspects according to one or more embodiments of the present disclosure are not restricted to those set forth herein. The above and other aspects of embodiments of the present disclosure will become more apparent to one of ordinary skill in the art to which the present disclosure pertains by referencing the detailed description of the present disclosure given below.

According to an embodiment of the present disclosure, a window for a display device includes: a base substrate; and a protective layer on the base substrate, wherein the protective layer includes a plurality of sub-layers sequentially stacked, wherein the base substrate and the protective layer include at least one material selected from the group consisting of polyimide, polyethylene naphthalate, polycarbonate, polyurethane, polydimethylenesiloxane, rubber, and polyethylene terephtahlate, wherein the plurality of sub-layers are formed of different materials.

The protective layer may include a first sub-layer formed of a first material and a second sub-layer formed of a second material different from the first material. Each of the first sub-layer and the second sub-layer may independently include at least one material selected from the group consisting of polyimide, polyethylene naphthalate, polycarbonate, polyurethane, polydimethylenesiloxane, rubber, and polyethylene terephtahlate.

The first sub-layer may be between the second sub-layer and the base substrate. The first sub-layer may have a thickness of 100 μm to 200 μm.

The second sub-layer may have a thickness of 30 μm to 80 μm.

The base substrate may be formed of polyimide, the first sub-layer may be formed of one or more materials selected from the group consisting of polyurethane, polydimethylenesiloxane, and rubber, and the second sub-layer may be formed of one or more materials selected from the group consisting of polyimide, polyethylene naphthalate, polycarbonate, and polyethylene terephthalate.

An elastic modulus of the first sub-layer may be 30 MPa to 70 MPa, and an elastic modulus of the second sub-layer may be 3.5 GPa to 7.0 GPa.

The base substrate may have a thickness of 30 μm to 50 μm.

The window may further include an adhesive layer between the base substrate and the protective layer. The adhesive layer may have an adhesive strength of 10 gf/in to 60 gf/in.

The window may further include an anti-fingerprint layer between the base substrate and the protective layer. The adhesive layer may have an adhesive strength of 10 gf/in to 40 gf/in.

The adhesive layer may have a thickness of 25 μm to 50 μm.

The window may have a radius of curvature of 10 mm or less.

When a pen having a weight of 5.7 g drops, a drop height of the pen, at which the window is damaged, may be 10 cm or higher.

According to an embodiment of the present disclosure, a display device includes: a display panel to display an image; and a window on the display panel, wherein the window includes: a base substrate; and a protective layer on the base substrate, wherein the protective layer includes a plurality of sub-layers sequentially stacked, wherein the base substrate and the protective layer include at least one material selected from the group consisting of polyimide, polyethylene naphthalate, polycarbonate, polyurethane, polydimethylenesiloxane, rubber, and polyethylene terephtahlate, wherein the plurality of sub-layers are formed of different materials.

The protective layer may include a first sub-layer formed of a first material and a second sub-layer formed of a second material different from the first material. Each of the first sub-layer and the second sub-layer may independently include at least one material selected from the group consisting of polyimide, polyethylene naphthalate, polycarbonate, polyurethane, polydimethylenesiloxane, rubber, and polyethylene terephtahlate.

The first sub-layer may be stacked between the second sub-layer and the base substrate. The first sub-layer may have a thickness of 100 μm to 200 μm.

The first sub-layer may have a thickness of 30 μm to 80 μm.

The base substrate may be formed of polyimide, the first sub-layer may be formed of one or more materials selected from the group consisting of polyurethane, polydimethylenesiloxane, and rubber, and the second sub-layer may be formed of one or more materials selected from the group consisting of polyimide, polyethylene naphthalate, polycarbonate, and polyethylene terephthalate.

The display device may have flexibility.

According to an embodiment of the present disclosure, a protective film for a window for a display device includes: a first sub-layer; and a second sub-layer, wherein the first sub-layer is formed of one or more materials selected from the group consisting of polyurethane, polydimethylenesiloxane, and rubber, and the second sub-layer is formed of one or more materials selected from the group consisting of polyimide, polyethylene naphthalate, polycarbonate, and polyethylene terephthalate.

The first sub-layer may have a thickness of 100 μm to 200 μm, and the second sub-layer may have a thickness of 30 μm to 80 μm.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a sectional view illustrating a section of a window for a display device according to an embodiment of the present disclosure.

FIG. 2 is a sectional view illustrating a section of a window for a display device according to another embodiment of the present disclosure.

FIG. 3 is a sectional view illustrating a section of a window for a display device, which has a radius of curvature of R1, according to an embodiment of the present disclosure.

FIG. 4 is a sectional view schematically illustrating the evaluation of surface property of a window for a display device according to an embodiment of the present disclosure.

FIGS. 5A and 5B are sectional views illustrating a display device according to an embodiment of the present disclosure.

### DETAILED DESCRIPTION

The present invention will be described more fully hereinafter, in which exemplary embodiments of the invention are shown and described. As those skilled in the art would realize, the described embodiments may be modified in various different ways, all without departing from the spirit or scope of the present invention. The drawings included are illustrated in a fashion where the figures are expanded for the better understanding.

Like numbers refer to like elements throughout. In the drawings, the thickness of certain lines, layers, components, elements or features may be exaggerated for clarity. It will be understood that, although the terms “first”, “second”, etc., may be used herein to describe various elements, these elements should not be limited by these terms. These terms are only used to distinguish one element from another element. Thus, a “first” element discussed below could also be termed a “second” element without departing from the teachings of the present disclosure. As used herein, the singular forms are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof. Further, an expression that an element such as a layer, region, substrate or plate is placed “on” or “above” another element indicates not only a case where the element is placed “directly on” or “just above” the other element but also a case where a further element is interposed between the element and the other element. Similarly, an expression that an element such as a layer, region, substrate or plate is placed “beneath” or “below” another element indicates not only a case where the element is placed “directly beneath” or “just below” the other element but also a case where a further element is interposed between the element and the other element.

In the disclosure, relative terms “top surface” and “bottom surface” are used as relative concepts to facilitate the understanding of the inventive concept. Therefore, “‘top surface” and “bottom surface” do not designate a specific direction, position, or component and may be interchangeable. For example, “top surface” may be interpreted as “bottom surface” and “bottom surface” may be interpreted as “top surface.” Therefore, “top surface” may be represented as “first surface” and “bottom surface” may be represented as “second surface,” while “top surface” may be represented as “second surface” and “bottom surface” may be represented as “first surface.” However, “top surface” and “bottom surface” are not mixed with each other in one embodiment.

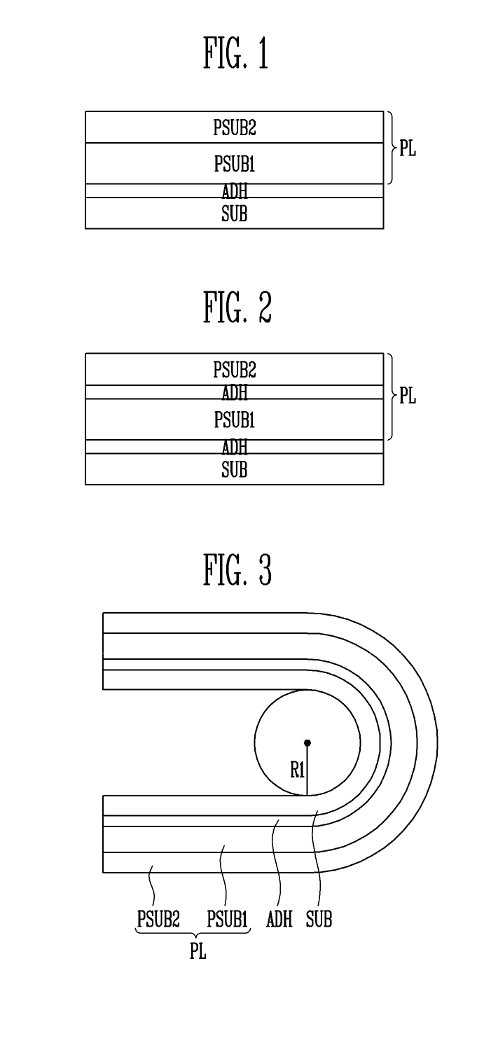

FIG. 1 is a sectional view illustrating a section of a window for a display device according to an embodiment of the present disclosure. FIG. 2 is a sectional view illustrating a section of a window for a display device according to another embodiment of the present disclosure.

As demands for flexible display devices increase and display devices including curved surfaces are increasingly utilized, the need of a window for a display device, which has flexibility and is bendable, has been increased. However, impact resistance and flexibility generally have a contradictory relationship. For example, when the flexibility is improved, the impact resistance may be relatively lowered. This is because the thickness of the window is desirably configured relatively thin so as to improve the flexibility. The relationship between the thickness and the flexibility may be expressed through (e.g., be represented by) the following Expression 1.

BS∝E×TH³ Expression 1

In Expression 1, BS denotes a bending strength of each layer, E denotes an elastic modulus of each layer, and TH denotes a thickness of each layer. The bending strength of the window is in proportion to the cube of the thickness of the window. Therefore, the thickness of the window is to be relatively small such that the window has a relatively small bending strength.

When the window is deformed as it is bent or folded, a repulsive force against the deformation is generated. The repulsive force (F) in the window against the deformation of the window may follow (e.g., be represented by) the following Expression 2.

$$F = \frac{wt}{6 Y} ( 1.19814 Y \frac{t}{D - t} ) \qquad Expression 2$$

In Expression 2, Y is a Young's modulus, t is a thickness of the window, w is a width of the window, and D is a distance between two end portions of the window, which face each other in the folded state. Here, D substantially corresponds to two times of the radius of curvature of the window. Therefore, the window may be set to have a radius of curvature of about 10 mm or less, which provides a satisfactory value of D corresponding thereto (e.g., 20 mm or less). According to Expression 2, in a state in which other conditions are the same and D is about 10 mm, the repulsive force when the thickness of the window is about 100 μm is about three times of the repulsive force when the thickness of the window is about 70 μm.

Therefore, when the display device and the window are bent, a large repulsive force may be applied to the window. In addition, when the thickness of the window is decreased so as to decrease the repulsive force and bending strength of the window, the window may be weak to external impact (e.g., may have low impact resistance against external impact).

The display device according to the present disclosure has excellent impact resistance while having a relatively thin thickness so as to ensure flexibility.

According to FIG. 1, the window according to the embodiment of the present disclosure includes a base substrate SUB and a protective layer PL provided on the base substrate SUB, and the protective layer PL has a plurality of sub-layers PSUB1 and PSUB2, which are sequentially stacked.

Hereinafter, each component of the window will be described in more detail.

The base substrate SUB may serve as a base of the window. For example, the window may be manufactured in a process where the base substrate SUB is first prepared, and the protective layer PL and an adhesive layer ADH are formed on the base substrate SUB.

Therefore, the base substrate SUB may be formed utilizing a material that has a relatively high hardness and excellent impact resistance. According to the present disclosure, the base substrate SUB may include at least one material selected from polyimide, polyethylene naphthalate, polycarbonate, polyurethane, polydimethylenesiloxane, rubber, and polyethylene terephthalate. Rubber may include at least one material selected from polyisoprene, polybutadiene, poly(styrene-butadiene-styrene), and polyisobutylene. The material for forming the base substrate SUB may be determined by considering the material of the protective layer PL to be formed on the base substrate SUB. Throughout this specification, the term “polyurethane” refers to both the polyurethane (e.g., thermoset polyurethane) and thermoplastic polyurethane.

When the material for forming the base substrate SUB is selected, the impact resistance and flexibility of the entire window as well as the material of the protective layer PL should be considered.

The base substrate SUB may have a thickness of about 30 μm to about 50 μm. When the thickness of the base substrate SUB is less than about 30 μm, the impact resistance of the window may be excessively lowered. In addition, when the thickness of the base substrate SUB exceeds about 50 μm, the flexibility of the window is lowered, and therefore, it may be difficult to apply the window to flexible display devices (e.g., the window may not be suitable for flexible display devices).

The base substrate SUB may have various suitable shapes according to the shape of the display device or the window. The base substrate SUB may have various suitable shapes when viewed on a plane. For example, the base substrate SUB may have shapes such as a rectangular shape, a square shape, a circular shape, an elliptical shape, a semicircular shape, and a semi-elliptical shape.

In one embodiment, the base substrate SUB is optically transparent. The term “optically transparent” refers to that the base substrate SUB allows light in a visible region to be transmitted therethrough without loss or distortion (e.g., without significant loss or distortion). For example, the base substrate SUB may have a transmittance of 90% or more with respect to light in a visible region. When the base substrate SUB has the above-described transmittance, light emitted from a display panel located under the base substrate SUB and further under the window can be viewed by a user without deterioration of luminance or distortion (e.g., without significant deterioration of luminance or distortion) caused by refraction.

The protective layer PL may be provided on the base substrate SUB. According to the present disclosure, the protective layer PL includes a plurality of sub-layers, e.g., PSUB1 and PSUB2. Although the protective layer PL including two sub-layers PSUB1 and PSUB2 is illustrated in FIG. 1, the number of sub-layers is not limited by the drawings. Those skilled in the art may select a protective layer including two or more sub-layers so as to optimize the flexibility, impact resistance, transmittance, etc., of the window.

As the protective layer PL includes the plurality of sub-layers PSUB1 and PSUB2, the window has not only excellent impact resistance but also excellent flexibility and surface characteristic. In one embodiment, in the window according to the present disclosure, the protective layer PL has excellent impact resistance and surface characteristic, as compared with a protective layer provided in a single layer.

The surface characteristic of the window may be evaluated through a scuff test. The scuff test may be performed by moving a solid object to the left and right in a state in which the window is pressed utilizing the object. In this case, the term “solid object” may refer to a metallic bar, ball, or the like. According to an embodiment of the present disclosure, the window may be pressed utilizing a metallic bar in the scuff test. For example, the scuff test may be performed by allowing a steel wool (Liberon #0000) to reciprocate ten times under a load of 1.5 kgf on a surface of the window, and checking whether a scratch has been generated in the surface of the window.

In this case, the force with which the metallic bar presses on the display device may be about 1.5 kgf. The force applied to the window in the scuff test represents a numerical value selected by considering the purpose of the window, i.e., the fact that the window is provided on a surface of the display device. It is assumed that when the window is generally utilized (e.g., under a typical usage condition), the load applied to the window hardly exceeds about 1.5 kgf. Therefore, it can be seen that if a window for a display device can endure a scuff test performed under a load of about 1.5 kgf, the window has impact resistance sufficient enough to be utilized in daily life.

In the scuff test, the metallic bar may reciprocate to the left and right plural times. As the metallic bar reciprocates to the left and right, the impact resistance and surface characteristic of the display device may be evaluated. The surface characteristic may include slipperiness. The slipperiness indicates whether a surface is relatively smooth due to low surface friction. When the slipperiness is low as the surface friction is relatively high, the window may be broken due to friction between the window and the metallic bar.

The window according to the present disclosure includes the protective layer PL including the plurality of sub-layers PSUB1 and PSUB2, and accordingly, has excellent surface characteristic, for example, slipperiness. Therefore, the window is not broken in the scuff test.

According to the present disclosure, the protective layer PL may include at least one material selected from polyimide, polyethylene naphthalate, polycarbonate, polyurethane, polydimethylenesiloxane, rubber, and polyethylene terephthalate. Rubber may include at least one material selected from polyisoprene, polybutadiene, poly(styrene-butadiene-styrene), and polyisobutylene. Here, the statement that the protective layer PL includes the material refers to that the plurality of sub-layers PSUB1 and PSUB2 (e.g., at least one of the plurality of sub-layers PSUB1 and PSUB2) included in the protective layer PL include the material.

The plurality of sub-layers PSUB1 and PSUB2 may be formed of different materials. In this case, the different materials that form the plurality of sub-layers PSUB1 and PSUB2 may be selected from polyimide, polyethylene naphthalate, polycarbonate, polyurethane, polydimethylenesiloxane, rubber, and polyethylene terephthalate.

In the present disclosure, the statement that the plurality of sub-layers PSUB1 and PSUB2 are formed of different materials refers to not only a case where the materials constituting the plurality of sub-layers PSUB1 and PSUB2 are completely different but also a case where some materials are the same but the most important materials (e.g., the material that constitutes majority of the respective layer by weight) among the materials constituting the respective sub-layers are different. For example, except when a first sub-layer PSUB1 is made of 100 wt % polyurethane and a second sub-layer PSUB2 is made of 100 wt % polyethylene terephthalate, the first sub-layer PSUB1 and the second sub-layer PSUB2 may be referred to as formed of different materials even when the first sub-layer PSUB1 is made of 90 wt % polyurethane and 10 wt % polycarbonate and the second sub-layer PSUB2 is made of 90 wt % polyethylene terephthalate and 10 wt % polycarbonate. Even when the first sub-layer PSUB1 and the second sub-layer PSUB2 include the same auxiliary additive, e.g., a leveling agent, a curing agent, a moistening agent, a filler, and/or the like, the first sub-layer PSUB1 and the second sub-layer PSUB2 may be referred to as formed of different materials (e.g., different main materials).

Therefore, the statement that the first sub-layer PSUB1 and the second sub-layer PSUB2 are formed of different materials may refer to that, in compositions of materials constituting the two sub-layers PSUB1 and PSUB2, a majority or more of the materials in the compositions of the respective sub-layers are different.

Even when the protective layer PL includes three or more sub-layers, the sub-layers may be formed of materials different from one another. For example, when the protective layer PL includes a first sub-layer, a second sub-layer, and a third sub-layer, the three sub-layers may be all formed of different materials. Here, the statement that the sub-layers are formed of materials different from one another refers to a case where no overlapping material exists in compositions of the three sub-layers, and a case where a majority of the materials are different materials or the overlapping materials are included in the compositions of the three sub-layers at a minor amount (e.g., less than 50% by weight).

The composition of each of the sub-layers PSUB1 and PSUB2 included in the protective layer PL may be determined by considering the impact resistance, surface characteristic (slipperiness), abrasion resistance, transmittance, flexibility, etc., of the window.

The protective layer PL may also have various suitable shapes. Because the protective layer PL is formed on the base substrate SUB, the shape of the protective layer PL may be substantially the same as or similar to that of the base substrate SUB. For example, the protective layer PL may have shapes such as a rectangular shape, a square shape, a circular shape, an elliptical shape, a semicircular shape, and a semi-elliptical shape.

However, in some cases, the area (e.g., surface area) of the protective layer PL on a plane may be different from that of the base substrate SUB on a plane. For example, the area of the protective layer PL may be larger than that of the base substrate SUB. Such a difference in area may occur when a curved surface is included in the base substrate SUB. When the curvature of the curved surface is large, the protective layer PL that is located relatively outside and has a relatively larger curvature may have an area wider than that of the protective layer PL that is located relatively inside and has a relatively smaller curvature. In one embodiment, the area of the protective layer PL may be smaller than that of the base substrate SUB. In this case, the protective layer PL is not provided on a partial region of the base substrate SUB.

The protective layer PL may be formed on the base substrate SUB utilizing various suitable methods. However, because each of the material constituting the protective layer PL and the material constituting the base substrate SUB is an organic material, a process temperature is, for example, maintained not to be excessively high. For example, the protective layer PL may be formed on the base substrate SUB utilizing a method such as slot die coating, dual web coating, gravure coating, roll coating, comma coating, air-knife coating, kiss coating, spray coating, curtain-flow coating, dip coating, spinner coating, whirler coating, brush coating, solid coating by a silk screen, wire-bar coating, flow coating, offset printing, and letterpress printing. The method for forming the protective layer PL may be selected by considering the composition and process efficiency of the protective layer PL. For example, the protective layer PL may be formed through slot die coating. However, when the process efficiency is considered, the protective layer PL may be formed through dual web coating.

When the protective layer PL includes a plurality of sub-layers PSUB1 and PSUB2, the sub-layers may be sequentially formed on the base substrate SUB. In this case, the method for forming each sub-layer may be different (e.g., different for each sub-layer). However, the sub-layers may be formed utilizing the same method when the process efficiency and the (e.g., the cost of) manufacturing of process equipment are considered.

According to an embodiment of the present disclosure, the protective layer PL may include a first sub-layer PSUB1 and a second sub-layer PSUB2. Each of the first sub-layer PSUB1 and the second sub-layer PSUB2 may independently include at least one material selected from polyimide, polyethylene naphthalate, polycarbonate, polyurethane, polydimethylenesiloxane, rubber, and polyethylene terephthalate. The first sub-layer PSUB1 and the second sub-layer PSUB2 are formed of materials different from each other. The meaning that the first sub-layer PSUB1 and the second sub-layer PSUB2 are formed of materials different from each other is the same as described above.

When the protective layer PL includes the first sub-layer PSUB1 and the second sub-layer PSUB2, the first sub-layer PSUB1 and the second sub-layer PSUB2 may be determined (e.g., identified) according to the position relationship of the first sub-layer PSUB1 and the second sub-layer PSUB2 with the base substrate SUB. The first sub-layer PSUB1 may be a sub-layer provided between the second sub-layer PSUB2 and the base substrate SUB.

The thickness of the first sub-layer PSUB1 located relatively closer to the base substrate SUB than the second sub-layer PSUB2 may be thicker than that of the second sub-layer PSUB2. Because the first sub-layer PSUB1 is located close to the base substrate SUB and is relatively thick, the first sub-layer PSUB1 may perform a function of improving the impact resistance of the window. However, the thickness of the first sub-layer PSUB1 is determined within a range where the flexibility of the window is not lowered while improving the impact resistance of the window.

According to an embodiment of the present disclosure, the first sub-layer PSUB1 may have a thickness of about 100 μm to about 200 μm. When the thickness of the first sub-layer PSUB1 is less than about 100 μm, the effect that the impact resistance of the window is improved by the first sub-layer PSUB1 is decreased, and therefore, the window may be weak to external impact. On the other hand, when the thickness of the first sub-layer PSUB1 exceeds about 200 μm, the flexibility of the window may be lowered. This is because, as described above, the bending strength of the window increases when the thickness of the first sub-layer PSUB1 increases.

According to an embodiment of the present disclosure, the second sub-layer PSUB2 may be provided on the first sub-layer PSUB1. The second sub-layer PSUB2 may have a thickness relatively smaller than that of the first sub-layer PSUB1. The second sub-layer PSUB2 may also perform a function of improving the impact resistance of the window. However, because the second sub-layer PSUB2 is relatively thinner than the first sub-layer PSUB1 and is provided more distant from the based substrate SUB than the first sub-layer PSUB1, the second sub-layer PSUB2 may perform a function of improving the surface characteristic of the window. The second sub-layer PSUB2 may improve the slipperiness of the window and reduce or prevent deformation of the window under a reliability evaluation condition such as a high-temperature/high-humidity environment or a low-temperature environment.

The second sub-layer PSUB2 may have a thickness of about 30 μm to about 80 μm. When the thickness of the second sub-layer PSUB2 is less than about 30 μm, the effect that the impact resistance of the window is improved by the second sub-layer PSUB2 may be decreased. On the other hand, when the thickness of the second sub-layer PSUB2 exceeds about 80 μm, the effect that the deformation of the window is reduced or prevented under the reliability evaluation condition may be decreased.

According to an embodiment of the present disclosure, the first sub-layer PSUB1 may be formed of one or more materials selected from polyurethane, polydimethylsiloxane, and rubber, and the second sub-layer PSUB2 may be formed of one or more materials selected from polyimide, polyethylene naphthalate, polycarbonate, and polyethylene terephthalate. In addition, the base substrate SUB may be formed of polyimide. Therefore, the window according to the embodiment of the present disclosure may have a form in which the base substrate SUB/the first sub-layer PSUB1/the second sub-layer PSUB2 are sequentially stacked, and the base substrate SUB/the first sub-layer PSUB1/the second sub-layer PSUB2 may be configured through combinations such as polyimide/polyurethane/polyethylene terephthalate, polyimide/polyurethane/polyethylene naphthalate, and polyimide/polyurethane/polyimide. However, the listed combinations are merely illustrative, and those skilled in the art may allow the base substrate SUB/the first sub-layer PSUB1/the second sub-layer PSUB2 to be configured through various suitable combinations as well as the listed combinations.

According to an embodiment of the present disclosure, the first sub-layer PSUB1 may have an elastic modulus of about 30 MPa to about 70 MPa. In addition, the second sub-layer PSUB2 may have an elastic modulus of about 3.5 GPa to about 7.0 GPa. When each of the first sub-layer PSUB1 and the second sub-layer PSUB2 has an elastic modulus within the above-described ranges, the window can have excellent flexibility and impact resistance.

When the elastic modulus of the first sub-layer PSUB1 is less than about 30 MPa or when the elastic modulus of the second sub-layer PSUB2 is less than about 3.5 GPa, the first sub-layer PSUB1 and the second sub-layer PSUB2 may not sufficiently absorb external impact applied to the window. When external impact is applied to the window, the protective layer PL and the base substrate SUB are compressed and bent in the impact direction. Here, the first sub-layer PSUB1 and the second sub-layer PSUB2 are compressed in the impact direction and then again restored, thereby absorbing the external impact. Each sub-layer may have an elastic modulus of the above-described respective numerical value or greater such that the first sub-layer PSUB1 and the second sub-layer PSUB2 absorb the external impact through the compression and restoration thereof.

When the elastic modulus of the first sub-layer PSUB1 exceeds about 70 MPa or when the elastic modulus of the second sub-layer PSUB2 exceeds about 7.0 GPa, the bending strength of the window increases. As a result, the flexibility of the window may be lowered.

An adhesive layer ADH may be further provided on the base substrate SUB. For example, the adhesive layer ADH may be provided between the base substrate SUB and the protective layer PL. In addition, the adhesive layer ADH may also be provided on the protective layer PL, if necessary. Referring to FIG. 2, the adhesive layer ADH may be provided between the base substrate SUB and the first sub-layer PSUB1 and between the first sub-layer PSUB1 and the second sub-layer PSUB2. Whether the adhesive layer ADH is provided between the first sub-layer PSUB1 and the second sub-layer PSUB2 may be determined by considering the material, thickness, etc., of each of the first sub-layer PSUB1 and the second sub-layer PSUB2. For example, when the first sub-layer PSUB1 and the second sub-layer PSUB2 are (e.g., capable of being) well attached to each other at an interface therebetween without any separate adhesive material, the adhesive layer ADH may not be provided between the first sub-layer PSUB1 and the second sub-layer PSUB2.

The adhesive layer ADH may include an optically clear adhesive (OCA), a pressure sensitive adhesive (PSA), and the like. An image output from the display device to be viewed by a user is transmitted through the adhesive layer ADH, and therefore, the adhesive layer ADH may be optically transparent. The adhesive layer ADH may be formed of a urethane-based composition, an acrylic-based composition, a silicon-based composition, and/or the like. The adhesive layer ADH may be formed utilizing various suitable materials in addition to the listed materials.

The adhesive layer ADH may be formed utilizing a method of applying the adhesive layer ADH in a liquid composition form and then curing the adhesive layer ADH, a method of forming the adhesive layer ADH in a film form and then attaching the adhesive layer ADH, or the like. The method for forming the adhesive layer ADH may be appropriately selected according to the kind of material constituting the adhesive layer ADH and the thickness of the adhesive layer ADH.

The adhesive layer ADH may have a thickness of about 25 μm to about 50 μm. When the thickness of the adhesive layer ADH is less than about 25 μm, the adhesive strength of the adhesive layer ADH may not be sufficient, and therefore, the coupling between components (e.g., adjacent layers) may be unstable. In addition, when the thickness of the adhesive layer ADH exceeds about 50 μm, the thickness of the window increases, and therefore, a defect may occur in driving of the display device provided under the window.

The adhesive layer ADH performs a function of allowing different components in the window to be attached to each other, and may also perform a function of dispersing stress applied to the window. For example, the adhesive layer ADH may disperse compressive stress or tensile stress applied to the window when the window is bent or curved. Also, the adhesive layer ADH may disperse external impact applied to the window.

In order to disperse stress or external impact applied to the window, the adhesive layer ADH may have an elastic modulus of about 0.03 MPa to about 0.2 MPa. The adhesive layer ADH along with the protective layer PL may absorb and disperse stress or external impact applied to the window while being compressed and then restored. Therefore, as the window includes the adhesive layer ADH having an elastic modulus within the above-described range, the impact resistance and flexibility of the window can be improved.

According to an embodiment of the present disclosure, the adhesive layer ADH may have an adhesive strength of about 10 gf/in to about 60 gf/in. When the adhesive strength of the adhesive layer ADH is less than about 10 gf/in, the adhesion between the base substrate SUB and the protective layer PL may be unstable. When the adhesion between the base substrate SUB and the protective layer PL is unstable, the protective layer PL may be separated from the base substrate SUB. Such a phenomenon may occur particularly when the window has flexibility and is repeatedly bent or folded. When the adhesive strength of the adhesive layer ADH exceeds about 60 gf/in, it is difficult to separate the protective layer PL from the base substrate SUB.

According to an embodiment of the present disclosure, an anti-fingerprint layer may be further provided between the base substrate SUB and the adhesive layer ADH. In this case, the adhesive layer ADH may have an adhesive strength of about 10 gf/in to about 40 gf/in. The anti-fingerprint layer improves the surface characteristic of the window. Because the surface of the anti-fingerprint layer has a low frictional coefficient and high slipperiness, the surface characteristic of the window can be improved. The anti-fingerprint layer has a water repellent characteristic in which the contact angle of the anti-fingerprint layer with water is about 100 degrees to about 116 degrees, so that the surface characteristic of the window can be improved.

The anti-fingerprint layer may prevent or substantially prevent a fingerprint of a user from being left on the surface of the window when the user touches the window. In addition, because the anti-fingerprint layer has an anti-fouling characteristic, the anti-fingerprint layer may substantially prevent or prevent a pollutant from remaining on the surface of the window. The anti-fingerprint layer may have a thickness of about 100 Å to about 200 Å. When the thickness of the anti-fingerprint layer is less than about 100 Å, it may be difficult to form and stack (e.g., laminate) the anti-fingerprint layer. When the thickness of the anti-fingerprint layer exceeds about 200 Å, the thickness of the window may excessively increases, and there may occur a problem such as lowering the sensitivity of the window.

The anti-fingerprint layer may be formed of a fluorine- or silicon-based resin. However, those skilled in the art may form the anti-fingerprint layer by utilizing an appropriate material as well as the resin (e.g., the fluorine- or silicon-based resin). The anti-fingerprint layer may be applied in a liquid composition form onto the window and then cured. Alternatively, the anti-fingerprint layer may be formed in a film form and then stacked (e.g., laminated) on the window. When the anti-fingerprint layer is formed in the film form and then stacked on the window, the adhesive layer ADH may be provided between the window and the anti-fingerprint layer.

The adhesive strength of the adhesive layer ADH may be changed depending on a position at which the anti-fingerprint layer is provided. For example, when the anti-fingerprint layer is provided on the top surface of the base substrate SUB, i.e., between the base substrate SUB and the protective layer PL, the adhesive layer ADH may have an adhesive strength of about 10 gf/in to about 40 gf/in. When the adhesive layer ADH has an adhesive strength within the above-described range, the anti-fingerprint layer and the protective layer PL on the substrate SUB may be separated/re-attached. When the adhesive strength of the adhesive layer ADH is less than about 10 gf/in, the adhesion between the base substrate SUB and the protective layer PL may be unstable. When the adhesive strength of the adhesive layer ADH exceeds about 40 gf/in, the separation/re-attachment between the anti-fingerprint layer and the protective layer PL may be difficult. As the separation/re-attachment of the protective layer PL is possible, the protective layer PL may be separated from the base substrate SUB and then re-attached to the base substrate SUB. For example, when the protective layer PL is damaged by external impact or when photorefraction or diffused reflection may occur at the surface of the protective layer PL as the surface of the protective layer PL is abraded, a new protective layer PL may be attached to the base substrate SUB after the damaged protective layer PL is separated from the base substrate SUB.

The anti-fingerprint layer may be located on the top surface of the protective layer PL in addition to the top surface of the base substrate SUB. For example, a case where the anti-fingerprint layer is provided on only the top surface of the base substrate SUB, a case where the anti-fingerprint layer is provided on only the top surface of the protective layer PL, and a case where the anti-fingerprint layer is provided on each of the top surface of the base substrate SUB and the top surface of the protective layer PL are all possible. Those skilled in the art may select whether the anti-fingerprint layer is stacked (e.g., included) and/or the position at which the anti-fingerprint layer is stacked according to the purpose of the display device or the window.

The window may further include a hard coating layer. The hard coating layer may be formed utilizing acrylic resin, epoxy resin, and/or the like, and the thickness of the hard coating layer may be about 5 μm to about 10 μm. The hard coating layer is a layer having a high hardness, and may have an indentation hardness of about 50 HV or more. When the hard coating layer has a high hardness as described above, the window can be protected from an external impact, for example, a point impact. The point impact refers to the case where a high pressure is applied to a narrow (e.g., small) area. The point impact may occur when a display panel is stabbed (e.g., pressed) by a sharp object such as a pen. The hard coating layer may be provided on any one or both of the top surface of the base substrate SUB and the top surface of the protective layer PL. However, when the anti-fingerprint layer is provided in the window, the hard coating layer is, in one embodiment, provided under the anti-fingerprint layer such that the anti-fingerprint layer may exhibit its surface characteristic.

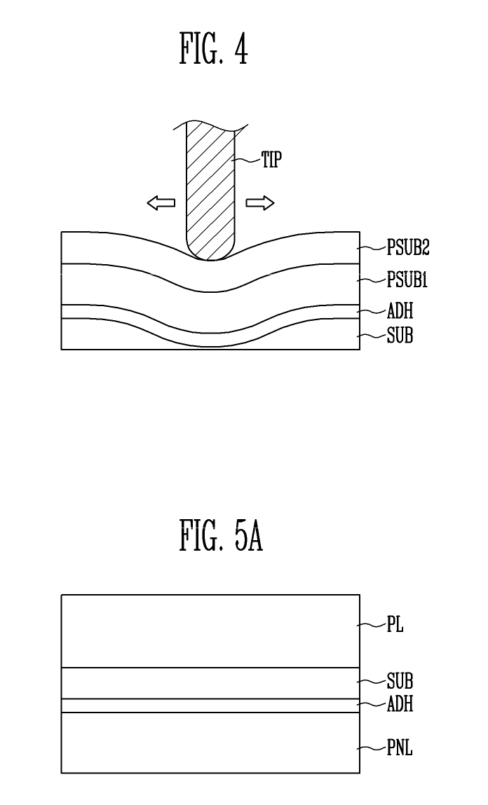

FIG. 3 is a sectional view illustrating a section of a window for a display device, which has a radius of curvature R1, according to an embodiment of the present disclosure.

According to an embodiment of the present disclosure, the window has a radius of curvature R1 of 10 mm or less. The window may not be broken even at a radius of curvature R1 of 10 mm, and the protective layer PL may not be separated from the base substrate SUB at the radius of curvature R1. Because the window has the radius of curvature R1 of 10 mm or less, the window can be applied to flexible display devices and displays including various curved surfaces.

FIG. 4 is a sectional view schematically illustrating the evaluation of surface property of a window for a display device according to an embodiment of the present disclosure.

As described above, the surface characteristic of the window may be evaluated through a scuff test. The scuff test may be performed by moving a solid object to the left and right in a state in which the window is pressed utilizing the object. When the surface characteristic of the window, for example, slipperiness is low, the surface of the window may be abraded (e.g., scratched) or broken as the solid object moves on the surface of the window. Because the surface characteristic of the window according to the present disclosure is excellent, the window is not abraded or broken in the scuff test.

In addition, the impact resistance of the window may be evaluated through the scuff test. FIG. 4 illustrates a state in which one side of the window is pressed utilizing a bar made of a hard material (e.g., a metal bar). FIG. 4 is exaggerated for convenience of description, but as can be seen in FIG. 4, each layer of the window is compressed and deformed when the window is pressed utilizing the metal bar.

When the metal bar is moved to the left and right in the deformed state, the deformation shape and compression shape of each layer of the window may be changed. At this time, if each layer of the window does not have a sufficient elastic modulus, the window is broken due to the compression and movement caused by the metal bar.

Each layer of the window according to the present disclosure has an elastic modulus within the respective ranges described earlier, so that the window is not broken even in the scuff test shown in FIG. 4 and a pen drop test to be described later.

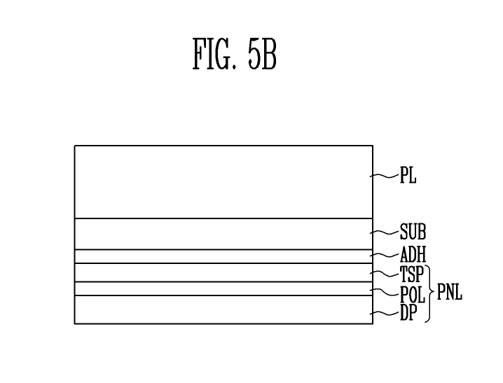

FIGS. 5A and 5B are sectional views illustrating sections of a display device according to an embodiment of the present disclosure.

A display panel PNL may be provided on the bottom of a window. The display panel PNL refers to the part of the display device that outputs an image. The display panel PNL may include a display unit DP that selectively emits light in a specific wavelength band, thereby outputting an image; a polarizing layer POL for filtering the vibration direction of the output light; a touch panel TSP for sensing a touch of a user; and/or the like.

The display unit DP may include an organic light emitting device or may include a light source and a liquid crystal layer. In addition, at least two electrodes may be provided in the display unit DP. The alignment of liquid crystal molecules in the liquid crystal layer or the emission of the organic light emitting device may be controlled according to an electric field provided between the two electrodes. In addition, the display unit DP may further include a plurality of transistors for controlling driving of the display device, a line unit, capacitors, and/or the like.

The touch panel TSP is utilized to sense a touch of a user, and may include various touch panels such as a resistive touch panel, a capacitive touch panel, an ultrasonic touch panel, or an infrared touch panel.

In one embodiment, after a window protective film including a first sub-layer and a second sub-layer is separately manufactured without any base substrate, the window protective film may be stacked on a base substrate. Here, the first sub-layer and the second sub-layer, which are included in the window protective film, are substantially the same as the first sub-layer and the second sub-layer in the above-described window.

Hereinafter, the window according to the present disclosure will be described through comparison between Examples and Comparative Examples.

Windows of Examples and Comparative Examples are configured as shown in Tables 1 and 2. In Tables 1 and 2, PI represents polyimide, PET represents polyethylene terephthalate, PEN represents polyethylene naphthalate, PU represents polyurethane, and TPU represents thermoplastic polyurethane. A numeral described next to a material name represents the thickness of each layer.

TABLE 1

| | Example 1 | Example 2 | Example 3 | Example 4 | Example 5 | Example 6 | Example 7 |
|---|---|---|---|---|---|---|---|
| Second | PET 50 μm | PEN 50 μm | PI 50 μm | PI 30 μm | PI 30 μm | PI 30 μm | PI 40 μm |
| sub-layer | | | | | | | |
| First | PU 150 μm | PU 150 μm | PU 150 μm | PU 150 μm | TPU 150 μm | PU 200 μm | PU 150 μm |
| sub-layer | | | | | | | |
| Base | PI 50 μm | PI 50 μm | PI 50 μm | PI 50 μm | PI 50 μm | PI 50 μm | PI 50 μm |
| substrate | | | | | | | |

TABLE 2

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Second | — | — | — | PI 30 μm | PI 30 μm | PI 20 μm | PI 100 μm |
| sub-layer | | | | | | | |
| First | — | TPU 150 μm | PET 23 μm | TPU 50 μm | TPU 300 μm | PU 150 μm | TPU 150 μm |
| sub-layer | | | | | | | |
| Base | PI 50 μm | PI 50 μm | PI 50 μm | PI 50 μm | PI 50 μm | PI 50 μm | PI 50 μm |
| substrate | | | | | | | |

Among the Examples disclosed in Table 1, each of the windows of Example 1 to 7 further includes a hard coating layer and an anti-fingerprint layer, which are sequentially stacked on a base substrate. In each of the windows of Examples 1 to 7, an adhesive layer formed of a pressure sensitive adhesive having a thickness of about 25 μm is provided between the base substrate and the protective layer. The hard coating layer and the anti-fingerprint layer, which are made of TPU and have a thickness of about 5 μm, are sequentially stacked on the top surface of the second sub-layer. In Example 5, the other components are the same as those of Examples 1 to 4, but the window further includes an adhesive layer formed of a pressure sensitive adhesive having a thickness of about 25 μm, which is provide between the first sub-layer and the second sub-layer.

Each of the windows of Comparative Examples 1 to 7 also includes a hard coating layer and an anti-fingerprint layer, which are sequentially stacked on a base substrate. In Comparative Examples 2 to 7, an adhesive layer formed of a pressure sensitive adhesive having a thickness of about 25 μm is provided between the base substrate and the protective layer. The hard coating layer and the anti-fingerprint layer are sequentially stacked on the top surface of the protective layer.

Property evaluations are performed on the windows of Examples 1 to 7 and Comparative Examples 1 to 7, which are disclosed in Tables 1 and 2.

The property evaluations are performed with respect to impact resistance and surface characteristic.

First, an impact resistance evaluation is performed through a window drop test, a pen drop test, and a ball drop test. The window drop test is performed to measure a drop height at which the window is damaged when the window is dropped from that drop height. As the drop height increases, impact power applied to the window increases, and thus the impact resistance of the window increases (e.g., is excellent).

The pen drop test may be performed by allowing a pen having a weight of about 5.7 g to drop onto the window. In the pen drop test, the impact resistance evaluation may be performed by measuring a drop height of the pen, at which the window is damaged. As the drop height of the pen becomes higher, the impact resistance of the window becomes better (e.g., more excellent). In particular, the pen drop test is useful in checking the impact resistance with respect to a point impact. As described above, the point impact refers to a case where a high pressure is applied to a narrow (e.g., small) area. The point impact may occur when a display panel is stabbed (e.g., pressed) by a sharp object such as a pen. When the window does not sufficiently buffer the point impact, the display panel disposed on the bottom of the window may be bent by the impact.

The ball drop test may be performed by disposing a chisel or wedge on the window and allowing a drop weight having a mass (e.g., can also be referred to as weight) of about 10 g to drop at a height of 1 cm or higher on the chisel or wedge. In the ball drop test, the impact resistance evaluation may be performed by measuring a drop height of the drop weight, at which the window is damaged. As the drop height of the drop weight becomes higher, the impact resistance of the window becomes better (e.g., more excellent). In particular, the ball drop test is useful in checking impact resistance with respect to a surface impact. The surface impact refers to a case where a high pressure is applied to a wide (e.g., large) area. The surface impact may occur when the window is pressed. When the window does not sufficiently buffer the surface impact, the display panel disposed on the bottom of the window may be broken while being stretched.

The surface characteristic is performed through a scuff test. The scuff test is substantially the same as described above. In this evaluation, the window is pressed with a load of 1.5 kgf utilizing a metallic bar, and the metallic bar reciprocates ten times to the left and right in the pressed state. After the completion of the metallic bar reciprocation, the damage or abrasion (e.g., scratches) of the window is checked.

Property evaluation results of the Examples and the Comparative Examples are shown in the following Tables 3 and 4.

TABLE 3

| | Example 1 | Example 2 | Example 3 | Example 4 | Example 5 | Example 6 | Example 7 |
|---|---|---|---|---|---|---|---|
| Window drop | 6 cm | 5 cm | 8 cm | 7 cm | 7 cm | 10 cm | 7 cm |
| test | | | | | | | |
| Pen drop | 11 cm | 11 cm | 18 cm | 14 cm | 14 cm | 20 cm | 15 cm |
| test | | | | | | | |
| Ball drop test | 7 cm | 7 cm | 11 cm | 9 cm | 9 cm | 11 cm | 9 cm |
| Surface | No | No | No | No | No | No | No |
| characteristic | damage | damage | damage | damage | damage | damage | damage |
| evaluation | | | | | | | |
| (scuff test) | | | | | | | |

TABLE 4

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Window drop | 1 cm | 5 cm | 3 cm | 2 cm | 10 cm | 7 cm | 12 cm |
| test | | | | | | | |
| Pen drop | 4 cm | 7 cm | 5 cm | 5 cm | 30 cm | 10 cm | 30 cm |
| test | | | | | | | |
| Ball drop test | 3 cm | 4 cm | 5 cm | 5 cm | 13 cm | 6 cm | 15 cm |
| Surface | No damage | Damaged | No damage | No damage | Damaged | No damage | Occurrence |
| characteristic | | | | | | | of buckling |
| evaluation | | | | | | | due to |
| (scuff test) | | | | | | | lowering of |
| | | | | | | | flexibility |

Referring to Tables 3 and 4, the windows of Examples 1 to 7 all show results of 5 cm or more in the window drop test, results of 11 cm or more in the pen drop test, and results of 7 cm or more in the ball drop test. The impact resistance of the above-described level has no problem (e.g., is adequate) in utilizing the window on a display device to be utilized in real life. In addition, as for the surface characteristic, all of the windows of the Examples are not damaged in the scuff test.

On the other hand, it can be seen that the impact resistance of the windows of Comparative Examples 1 to 4 and 6 is slightly lowered. Further, the surface characteristic of the window of Comparative Example 2 is lowered, and therefore, the window of Comparative Example 2 is damaged in the scuff test. The impact resistance of the windows of Comparative Examples 5 and 7 has no problem, but the surface characteristic or flexibility of the windows of Comparative Examples 5 and 7 is lowered. Therefore, the windows of Comparative Examples 5 and 7 are damaged in the surface characteristic evaluation, or buckling occurs due to the lowering of flexibility.

As can be seen in the property evaluation results of the Examples and the Comparative Examples, the window according to the present disclosure includes a plurality of sub-layers, to obtain excellent impact resistance and surface characteristic. Furthermore, because the window according to the present disclosure has excellent impact resistance, the window can be formed thin. Accordingly, the flexibility of the window can be improved.

In addition, as the base substrate and the protective layer are formed of at least one material selected from polyimide, polyethylene naphthalate, polycarbonate, polyurethane, polydimethylenesiloxane, rubber, and polyethylene terephthalate, the impact resistance and surface characteristic of the window according to the present disclosure can be optimized. In particular, as the first sub-layer and the second sub-layer, which are included in the protective layer, are formed of materials different from each other, the optimization of the impact resistance and surface characteristic can be achieved. Such an effect can be seen from comparison between Comparative Examples 2 and 3 and the Examples. The impact resistance of the protective layers of Comparative Examples 2 and 3, which are made of a single material, is lowered as compared with the protective layers of the Examples, which are made of combinations of two or more materials.

The effect of thickness ranges of the first sub-layer and the second sub-layer can be seen through comparison between Comparative Examples 4 to 7 and the Examples. The window according to the present disclosure includes a second sub-layer having a thickness of about 30 μm to about 80 μm and a first sub-layer having a thickness of about 100 μm to about 200 μm, to obtain optimized impact resistance and surface characteristic.

According to the present disclosure, it is possible to provide a window that has flexibility and excellent impact resistance. In addition, the window can have excellent surface characteristic.

Example embodiments have been disclosed herein, and although specific terms are employed, they are used and are to be interpreted in a generic and descriptive sense only and not for purpose of limitation. In some instances, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various suitable changes in form and details may be made without departing from the spirit and scope of the present disclosure as set forth in the following claims, and equivalent thereof.

What is claimed is:

1. A window for a display device, comprising:
a base substrate; and
a protective layer on the base substrate,
wherein the protective layer comprises a plurality of sub-layers sequentially stacked,
wherein the base substrate and the protective layer comprise at least one material selected from the group consisting of polyimide, polyethylene naphthalate, polycarbonate, polyurethane, polydimethylenesiloxane, rubber, and polyethylene terephtahlate,
wherein the plurality of sub-layers are formed of different materials.

2. The window of claim 1, wherein the protective layer comprises a first sub-layer formed of a first material and a second sub-layer formed of a second material different from the first material,
wherein each of the first sub-layer and the second sub-layer independently comprises at least one material selected from the group consisting of polyimide, polyethylene naphthalate, polycarbonate, polyurethane, polydimethylenesiloxane, rubber, and polyethylene terephtahlate.

3. The window of claim 2, wherein the first sub-layer is between the second sub-layer and the base substrate, and
wherein the first sub-layer has a thickness of about 100 μm to about 200 μm.

4. The window of claim 3, wherein the second sub-layer has a thickness of about 30 μm to about 80 μm.

5. The window of claim 2, wherein the base substrate is formed of polyimide,
the first sub-layer is formed of one or more materials selected from the group consisting of polyurethane, polydimethylenesiloxane, and rubber, and
the second sub-layer is formed of one or more materials selected from the group consisting of polyimide, polyethylene naphthalate, polycarbonate, and polyethylene terephthalate.

6. The window of claim 2, wherein an elastic modulus of the first sub-layer is about 30 MPa to about 70 MPa, and an elastic modulus of the second sub-layer is about 3.5 GPa to about 7.0 GPa.

7. The window of claim 1, wherein the base substrate has a thickness of about 30 μm to about 50 μm.

8. The window of claim 1, further comprising an adhesive layer between the base substrate and the protective layer,
wherein the adhesive layer has an adhesive strength of about 10 gf/in to about 60 gf/in.

9. The window of claim 8, further comprising an anti-fingerprint layer between the base substrate and the protective layer,
wherein the adhesive layer has an adhesive strength of about 10 gf/in to about 40 gf/in.

10. The window of claim 9, wherein the adhesive layer has a thickness of about 25 μm to about 50 μm.

11. The window of claim 1, wherein the window has a radius of curvature of about 10 mm or less.

12. The window of claim 1, wherein, when a pen having a weight of about 5.7 g drops, a drop height of the pen, at which the window is damaged, is about 10 cm or higher.

13. A display device comprising:
a display panel to display an image; and
a window on the display panel,
wherein the window comprises:
a base substrate; and
a protective layer on the base substrate,
wherein the protective layer comprises a plurality of sub-layers sequentially stacked,
wherein the base substrate and the protective layer include at least one material selected from the group consisting of polyimide, polyethylene naphthalate, polycarbonate, polyurethane, polydimethylenesiloxane, rubber, and polyethylene terephtahlate,
wherein the plurality of sub-layers are formed of different materials.

14. The display device of claim 13, wherein the protective layer comprises a first sub-layer comprising a first material and a second sub-layer comprising a second material different from the first material,
wherein each of the first sub-layer and the second sub-layer independently comprises at least one material selected from the group consisting of polyimide, polyethylene naphthalate, polycarbonate, polyurethane, polydimethylenesiloxane, rubber, and polyethylene terephtahlate.

15. The display device of claim 14, wherein the first sub-layer is between the second sub-layer and the base substrate, and
wherein the first sub-layer has a thickness of about 100 μm to about 200 μm.

16. The display device of claim 15, wherein the second sub-layer has a thickness of about 30 μm to about 80 μm.

17. The display device of claim 14, wherein the base substrate is formed of polyimide,
the first sub-layer is formed of one or more materials selected from the group consisting of polyurethane, polydimethylenesiloxane, and rubber, and
the second sub-layer is formed of one or more materials selected from the group consisting of polyimide, polyethylene naphthalate, polycarbonate, and polyethylene terephthalate.

18. The display device of claim 13, wherein the display device has flexibility.

19. A protective film for a window for a display device, the protective film comprising:
a first sub-layer; and
a second sub-layer,
wherein the first sub-layer is formed of one or more materials selected from the group consisting of polyurethane, polydimethylenesiloxane, and rubber, and
the second sub-layer is formed of one or more materials selected from the group consisting of polyimide, polyethylene naphthalate, polycarbonate, and polyethylene terephthalate.

20. The protective film of claim 19, wherein the first sub-layer has a thickness of about 100 μm to about 200 μm, and the second sub-layer has a thickness of about 30 μm to about 80 μm.
